(19) United States
(12) Patent Application Publication
(10) Pub. No.: US 2025/0006929 A1
(43) Pub. Date: Jan. 2, 2025

(54) ELECTROCHEMICAL APPARATUS AND ELECTRONIC APPARATUS

(71) Applicant: Ningde Amperex Technology Limited, Ningde (CN)

(72) Inventors: Yawen HUANG, Ningde (CN); Wei TAO, Ningde (CN); Ao LIU, Ningde (CN); Lei LI, Ningde (CN)

(73) Assignee: Ningde Amperex Technology Limited, Ningde (CN)

(21) Appl. No.: 18/884,254

(22) Filed: Sep. 13, 2024

Related U.S. Application Data
(63) Continuation of application No. PCT/CN2022/081723, filed on Mar. 18, 2022.

(51) Int. Cl. H01M 4/587; H01M 4/02; H01M 4/133; H01M 4/62; H01M 10/0525

(52) U.S. Cl. CPC H01M 4/587; H01M 4/133; H01M 4/622; H01M 10/0525; H01M 2004/027

(57) ABSTRACT

An electrochemical apparatus includes a negative electrode plate, where the negative electrode plate includes a negative electrode current collector, a first layer, and a second layer. The first layer is disposed between the negative electrode current collector and the second layer. The first layer and the second layer both include graphite, and a ratio of crystallinity of graphite in the second layer to crystallinity of graphite in the first layer is 0.4 to 0.8. Using graphite with higher crystallinity in the first layer can achieve a higher capacity, increasing the energy density of the electrochemical apparatus; and using graphite with lower crystallinity in the second layer can avoid the problem of lithium precipitation on the surface of the high crystallinity graphite of the first layer, improving the kinetic performance of the electrochemical apparatus.

### CROSS-REFERENCE TO RELATED APPLICATIONS

This application is a continuation application of International Application No. PCT/CN2022/081723, filed on Mar. 18, 2022, the contents of which are incorporated herein by reference in its entirety.

### TECHNICAL FIELD

This application relates to the field of electrochemical energy storage and specifically to an electrochemical apparatus and an electronic apparatus.

### BACKGROUND

With the development of electrochemical energy storage technologies, higher requirements are being placed on the energy density and kinetic performance of electrochemical apparatuses (for example, lithium-ion batteries), and further improvements in this field are desired.

### SUMMARY

Some embodiments of this application provide an electrochemical apparatus. The electrochemical apparatus includes a negative electrode plate, where the negative electrode plate includes a negative electrode current collector, a first layer, and a second layer. The first layer is disposed between the negative electrode current collector and the second layer. The first layer and the second layer both include graphite, and a ratio of crystallinity of graphite in the second layer to crystallinity of graphite in the first layer is 0.4 to 0.8.

In some embodiments, the crystallinity of graphite in the second layer is 20 nm to 28 nm. In some embodiments, the crystallinity of graphite in the first layer is 30 nm to 50 nm. In some embodiments, a thickness ratio of the first layer to the second layer is 3 to 5. In some embodiments, a mass percentage of graphite in the first layer is 70% to 98%. In some embodiments, a mass percentage of graphite in the second layer is 70% to 98%. In some embodiments, the first layer further includes a first binder and a first dispersant, and the second layer includes a second binder and a second dispersant. In some embodiments, the first binder and the second binder each independently include at least one of polyacrylic acid, polyvinylpyrrolidone, polyanion, polyimide, polyamide-imide, polysiloxane, styrene-butadiene rubber, epoxy resin, polyester resin, polyurethane resin, or polyfluorene. In some embodiments, the first dispersant and the second dispersant each independently include at least one of carboxymethyl cellulose or carboxymethyl cellulose salt.

Some embodiments of this application further provide an electronic apparatus including the foregoing electrochemical apparatus.

In this application, using graphite with higher crystallinity in the first layer can achieve a higher capacity, increasing the energy density of the electrochemical apparatus; and using graphite with lower crystallinity in the second layer can avoid a problem of lithium precipitation on the surface of the high-crystallinity graphite of the first layer, improving the kinetic performance of the electrochemical apparatus.

### BRIEF DESCRIPTION OF DRAWINGS

FIG. 1 shows a cross-sectional view of a negative electrode plate according to some embodiments of this application.

### DETAILED DESCRIPTION

The following embodiments can help persons skilled in the art understand this application more comprehensively, but do not limit this application in any manner.

Graphite with high crystallinity has a low defect density as well as a high capacity and initial coulombic efficiency, but features poor kinetic performance and easily causes lithium precipitation on a surface of a negative electrode plate.

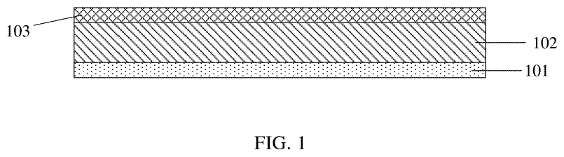

An embodiment of this application provides an electrochemical apparatus, and the electrochemical apparatus includes a negative electrode plate. FIGURE a cross-sectional view of a negative electrode plate in a width direction and in a thickness direction according to some embodiments. As shown in FIG. 1, the negative electrode plate includes a negative electrode current collector 101, a first layer 102, and a second layer 103, where the first layer 102 is disposed between the negative electrode current collector 101 and the second layer 103.

In some embodiments, the first layer 102 and the second layer 103 both include graphite, and a ratio of crystallinity of graphite in the second layer 103 to crystallinity of graphite in the first layer 102 is 0.4 to 0.8. In some embodiments, the crystallinity of graphite can be defined by Lc, and Lc is thickness of graphite sheets stacked along a c-axis perpendicular to a sheet plane. The crystallinity (Lc) of graphite can be tested using the following method, which is just an example and other suitable testing methods can also be used: an X-ray diffractometer (XRD, Bruker D8 Advance, Germany) is used to test an X-ray diffraction pattern of graphite powder, with a scanning range of 5°-80°. A diffraction peak within a range of 20°-30° corresponds to a (002) crystal plane, and a full width at half maximum β₀₀₂ corresponding to the (002) peak can be obtained, that is, a full width at half the maximum height of the (002) peak. Lc=K*λ/β₀₀₂*COSθ₀₀₂, where K=0.089, λ=1.54182 Å, θ₀₀₂ is the θ value corresponding to the (002) peak, and β₀₀₂ is the full width at half maximum of the (002) peak. Testing XRD of the surface layer of the negative electrode plate can provide crystallinity information of graphite in the second layer. After graphite on the surface layer is scrapped off using a scraper, performing XRD test again can provide crystallinity information of graphite in the first layer. A boundary between the first layer and the second layer can be identified by SEM of a cross section of the negative electrode plate.

The first layer close to the negative electrode current collector contains graphite with higher crystallinity, while the second layer away from the negative electrode current collector contains graphite with lower crystallinity. The low-crystallinity graphite in the second layer has more active sites, which is beneficial for lithium-ion intercalation and deintercalation, makes lithium precipitation less likely to occur, and allows for more sufficient contact between an electrolyte and the negative electrode plate. Graphite in the first layer has a low defect density and higher crystallinity, achieving a high capacity. Therefore, in a case of not losing the capacity, the problem of lithium precipitation on the surface of the first layer caused by high-crystallinity graphite can be effectively avoided when the first layer is used as the surface layer of the negative electrode plate, and the kinetic performance of the electrochemical apparatus can be effectively improved and cycling attenuation can be alleviated, enhancing the cycling performance of the electrochemical apparatus.

Additionally, if the ratio of the crystallinity of graphite in the second layer 103 to the crystallinity of graphite in the first layer 102 is excessively small, the defect density of graphite in the second layer 103 is usually excessively high, which is not conducive to structural stability. If the ratio of the crystallinity of graphite in the second layer 103 to the crystallinity of graphite in the first layer 102 is excessively large, the crystallinity of graphite in the first layer 102 is usually excessively low, which is not conducive to fully increasing the capacity of the electrochemical apparatus.

In some embodiments, the crystallinity of graphite in the second layer 103 is 20 nm to 28 nm. If the crystallinity of graphite in the second layer 103 is excessively small, the defect density of graphite in the second layer 103 is excessively high, which is not conducive to the structural stability of the graphite. If the crystallinity of graphite in the second layer 103 is excessively large, the effect of alleviating lithium precipitation on the surface of the negative electrode plate is limited. In some embodiments, the crystallinity of graphite in the first layer 102 is 30 nm to 50 nm. If the crystallinity of graphite in the first layer 102 is excessively small, the capacity of the electrochemical apparatus cannot be fully increased, If the crystallinity of graphite in the first layer 102 is excessively large, the requirement for the graphite material is higher, and the cost is also higher.

In some embodiments, a thickness ratio of the first layer 102 to the second layer 103 is 3 to 5. If the thickness ratio of the first layer 102 to the second layer 103 is excessively small, the second layer 103 is excessively thick, which is not conducive to fully utilizing the capacity of the high-crystallinity graphite in the electrochemical apparatus. If the thickness ratio of the first layer 102 to the second layer 103 is excessively large, the thickness of the second layer 103 is excessively small, and the effect of alleviating lithium precipitation on the surface of the negative electrode plate by the second layer 103 is relatively limited.

In some embodiments, a mass percentage of graphite in the first layer 102 is 70% to 98%. Excessively small mass percentage of graphite in the first layer 102 is not conducive to fully increasing the energy density of the electrochemical apparatus. If the mass percentage of graphite in the first layer 102 is excessively large, the percentage of another component (for example, a binder) in the first layer 102 is excessively small, which is not conducive to the overall structural stability of the first layer 102. In some embodiments, a mass percentage of graphite in the second layer 103 is 70% to 98%. Excessively small mass percentage of graphite in the second layer 103 is not conducive to fully increasing the energy density of the electrochemical apparatus. If the mass percentage of graphite in the second layer 103 is excessively large, the percentage of another component (for example, a binder) in the second layer 103 is excessively small, which is not conducive to the overall structural stability of the second layer 103.

In some embodiments, the first layer 102 further includes a first binder and a first dispersant, and the second layer 103 includes a second binder and a second dispersant. In some embodiments, the first binder and the second binder each independently include at least one of polyacrylic acid, polyvinylpyrrolidone, polyanion, polyimide, polyamide-imide, polysiloxane, styrene-butadiene rubber, epoxy resin, polyester resin, polyurethane resin, or polyfluorene. In some embodiments, the first dispersant and the second dispersant each independently include at least one of carboxymethyl cellulose or carboxymethyl cellulose salt. In some embodiments, the first layer 102 and the second layer 103 can each independently include at least one of silicon, silicon alloy, silicon oxide material, silicon-carbon material, hard carbon, or tin-based material.

In some embodiments, the negative electrode current collector may be at least one of copper foil, nickel foil, or carbon-based current collector. Certainly, other commonly used negative electrode current collectors in the field may also be used. In some embodiments, the negative electrode current collector may have a thickness of 1 μm to 200 μm.

In some embodiments, the electrochemical apparatus may include an electrode assembly, and the electrode assembly may include a separator, a positive electrode plate, and the foregoing negative electrode plate, where the separator is disposed between the positive electrode plate and the negative electrode plate. In some embodiments, the positive electrode plate may include a positive electrode current collector and a positive electrode active material layer, where the positive electrode active material layer is located on one side or two sides of the positive electrode current collector. In some embodiments, an aluminum (Al) foil may be used as the current collector of the positive electrode, or certainly other positive electrode current collectors commonly used in the art may be used. In some embodiments, the positive electrode current collector may have a thickness of 1 μm to 200 μm.

In some embodiments, the positive electrode active material layer may include a positive electrode active material, and the positive electrode active material may include at least one of lithium cobalt oxide, lithium manganese oxide, lithium iron phosphate, lithium nickel cobalt manganese oxide, lithium nickel cobalt aluminum oxide, or lithium nickel manganese oxide. In some embodiments, the positive electrode active material layer further includes a binder and a conductive agent. In some embodiments, the binder in the positive electrode active material layer may include at least one of polyvinylidene fluoride, vinylidene fluoride-hexafluoropropylene copolymer, styrene-acrylate copolymer, styrene-butadiene copolymer, polyamide, polyacrylonitrile, polyacrylic ester, polyacrylic acid, polyacrylic salt, carboxymethyl cellulose sodium, polyvinyl acetate, polyvinylpyrrolidone, polyvinylether, polymethyl methacrylate, polytetrafluoroethylene, or polyhexafluoropropylene. In some embodiments, the conductive agent in the positive electrode active material layer may include at least one of conductive carbon black, Ketjen black, laminated graphite, graphene, carbon nanotubes, or carbon fiber. In some embodiments, a mass ratio of the positive electrode active material, conductive agent, and binder in the positive electrode active material layer may be 91-99:0.5-3:0.5-6. It should be understood that the descriptions above are merely examples, and any other suitable materials, thicknesses, and mass ratios may be used for the positive electrode active substance layer.

In some embodiments, the separator includes at least one of polyethylene, polypropylene, polyvinylidene fluoride, polyethylene terephthalate, polyimide, or aramid. For example, polyethylene is at least one selected from high-density polyethylene, low-density polyethylene, or ultrahigh-molecular-weight polyethylene. Especially, polyethylene and polypropylene have a good effect on preventing short circuits and can improve stability of a battery through a shutdown effect. In some embodiments, thickness of the separator ranges from approximately 5 μm to 20 μm.

In some embodiments, a surface of the separator may further include a porous layer. The porous layer is disposed on at least one surface of the separator. The porous layer includes inorganic particles and a binder. The inorganic particles are at least one selected from aluminum oxide (Al₂O₃), silicon oxide (SiO₂), magnesium oxide (MgO), titanium oxide (TiO₂), hafnium dioxide (HfO₂), tin oxide (SnO₂), cerium dioxide (CeO₂), nickel oxide (NiO), zinc oxide (ZnO), calcium oxide (CaO), zirconia oxide (ZrO₂), yttrium oxide (Y₂O₃), silicon carbide (SiC), boehmite, aluminum hydroxide, magnesium hydroxide, calcium hydroxide, or barium sulfate. In some embodiments, a pore diameter of the separator ranges from approximately 0.01 μm to 1 μm. The binder of the porous layer is at least one selected from polyvinylidene fluoride, a vinylidene fluoride-hexafluoropropylene copolymer, polyamide, polyacrylonitrile, polyacrylate, polyacrylic acid, polyacrylate, sodium carboxymethyl cellulose, polyvinylpyrrolidone, polyvinyl ether, polymethyl methacrylate, polytetrafluoroethylene, or polyhexafluoropropylene. The porous layer on the surface of the separator can improve heat resistance, oxidation resistance, and electrolyte infiltration performance of the separator, and enhance adhesion between the separator and the electrode plates.

In some embodiments of this application, an electrode assembly of the electrochemical apparatus is a wound electrode assembly or a stacked electrode assembly.

In some embodiments, the electrochemical apparatus includes a lithium-ion battery but this application is not limited thereto. In some embodiments, the electrochemical apparatus may further include an electrolyte. The electrolyte may be one or more of gel electrolyte, solid electrolyte, and liquid electrolyte, and the liquid electrolyte includes a lithium salt and a non-aqueous solvent. The lithium salt is one or more selected from LiPF₆, LiBF₄LiAsF₆, LiClO₄, LiB(C₆H₅)₄, LiCH₃SO₃, LiCF₃SO₃, LiN(SO₂CF₃)₂, LiC(SO₂CF₃)₃, LiSiF₆, LiBOB, or lithium difluoro(oxalate)borate. For example, LiPF₆ is selected as the lithium salt because it can provide a high ionic conductivity and improve cycling performance.

The non-aqueous solvent may be selected from a carbonate compound, a carboxylate compound, an ether compound, another organic solvent, or a combination thereof.

The carbonate compound may be selected from a linear carbonate compound, a cyclic carbonate compound, a fluorocarbonate compound, or a combination thereof.

The linear carbonate compound may be selected from diethyl carbonate (DEC), dimethyl carbonate (DMC), dipropyl carbonate (DPC), methyl propyl carbonate (MPC), ethyl propyl carbonate (EPC), methyl ethyl carbonate (MEC), and a combination thereof. The cyclic carbonate compound may be selected from ethylene carbonate (EC), propylene carbonate (PC), butylene carbonate (BC), vinyl ethylene carbonate (VEC), or a combination thereof. The fluorocarbonate compound may be selected from fluoroethylene carbonate (FEC), 1,2-difluoroethylene carbonate, 1,1-difluoroethylene carbonate, 1,1,2-trifluoroethylene carbonate, 1,1,2,2-tetrafluoroethylene carbonate, 1-fluoro-2-methylethylene carbonate, 1-fluoro-1-methylethylene carbonate, 1,2-difluoro-1-methylethylene carbonate, 1,1,2-trifluoro-2-methylethylene carbonate, trifluoromethylethylene carbonate, or a combination thereof.

The carboxylate compound may be selected from methyl acetate, ethyl acetate, n-propyl acetate, tert-butyl acetate, methyl propionate, ethyl propionate, propyl propionate, γ-butyrolactone, decanolide, valerolactone, mevalonolactone, caprolactone, methyl formate, or a combination thereof.

The ether compound may be selected from dibutyl ether, tetraglyme, diglyme, 1,2-dimethoxyethane, 1,2-diethoxyethane, ethoxymethoxy ethane, 2-methyltetrahydrofuran, tetrahydrofuran, or a combination thereof.

The another organic solvent may be selected from dimethyl sulfoxide, 1,2-dioxolane, sulfolane, methyl sulfolane, 1,3-dimethyl-2-imidazolidinone, N-methyl-2-pyrrolidone, formamide, dimethylformamide, acetonitrile, trimethyl phosphate, triethyl phosphate, trioctyl phosphate, phosphate ester, or a combination thereof.

In some embodiments of this application, a lithium-ion battery is used as an example. A positive electrode plate, a separator, and a negative electrode plate are wound or stacked in sequence to form an electrode assembly, and the electrode assembly is then put into, for example, an aluminum-plastic film, followed by electrolyte injection, formation, and packaging, to prepare a lithium-ion battery. Then, a performance test is performed on the prepared lithium-ion battery.

Those skilled in the art will understand that the method for preparing the electrochemical apparatus (for example, the lithium-ion battery) described above is only an example. Without departing from the content disclosed in this application, other methods commonly used in the art may be used.

Some embodiments of this application further provide an electronic apparatus including the foregoing electrochemical apparatus. The electronic apparatus in some embodiments of this application is not particularly limited, and may be any known electronic apparatus used in the prior art. In some embodiments, the electronic apparatus may include but is not limited to a notebook computer, a pen-input computer, a mobile computer, an electronic book player, a portable telephone, a portable fax machine, a portable copier, a portable printer, a stereo headset, a video recorder, a liquid crystal television, a portable cleaner, a portable CD player, a mini-disc, a transceiver, an electronic notepad, a calculator, a memory card, a portable recorder, a radio, a standby power source, a motor, an automobile, a motorcycle, a power-assisted bicycle, a bicycle, a lighting appliance, a toy, a game console, a clock, an electric tool, a flash lamp, a camera, a large household battery, or a lithium-ion capacitor.

Some specific examples and comparative examples are listed below to better illustrate this application. Lithium-ion batteries are used for illustration.

### Comparative Example 1

Preparation of positive electrode plate: A positive electrode active material lithium cobalt oxide, a conductive agent conductive carbon black, and a binder polyvinylidene fluoride are dissolved in an N-methylpyrrolidone (NMP) solution based on a weight ratio 97.6:1.3:1.1, to obtain a positive electrode slurry. An aluminum foil was used as a positive electrode current collector. The positive electrode slurry was applied to the positive electrode current collector, and thickness of the applied positive electrode paste was 80 μm, followed by drying, cold pressing, and cutting, to obtain a positive electrode plate.

Preparation of negative electrode plate: a negative electrode active material graphite (crystallinity Lc=20 nm), a binder styrene-butadiene rubber, and a dispersant carboxymethyl cellulose sodium were dissolved in deionized water at a weight ratio of 98:1:1 to form a negative electrode slurry. A copper foil was used as a negative electrode current collector. The negative electrode slurry was applied to the negative electrode current collector, and thickness of the applied negative electrode paste was 115 μm, followed by drying, cold pressing, and cutting, to obtain a negative electrode plate.

Preparation of separator: Polyethylene (PE) with a thickness of 8 μm was used as a separator substrate, two sides of the separator substrate were each coated with a 2 μm aluminum oxide ceramic layer, and ultimately two sides of the ceramic layer were each coated with a 2.5 mg binder polyvinylidene fluoride (PVDF), followed by drying.

Preparation of electrolyte: In an environment with water content less than 10 ppm, lithium hexafluorophosphate and a non-aqueous organic solvent (a weight ratio of ethylene carbonate (EC):diethyl carbonate (DEC):propylene carbonate (PC):propyl propionate (PP):vinylene carbonate (VC) was equal to 20:30:20:28:2) were mixed at a weight ratio of 8:92 to prepare an electrolyte.

Preparation of lithium-ion battery: The positive electrode plate, the separator, and the negative electrode plate were stacked in sequence, so that the separator was disposed between the positive electrode plate and the negative electrode plate for separation, and winding was performed to obtain an electrode assembly. The electrode assembly was put in an outer package aluminum-plastic film and dehydrated at 80° C. Then, the foregoing electrolyte was injected and packaged, followed by processes such as formation, degassing, and trimming to obtain a lithium-ion battery with a thickness of 4 mm, a width of 35 mm, and a length of 80 mm.

Other comparative examples and examples involved parameter changes based on the steps of Comparative example 1 and differed from Comparative example 1 only in the preparation of the negative electrode plate. The crystallinity Lc of graphite in Comparative example 2 was 25 nm, and the crystallinity c of graphite in Comparative example 3 was 35 nm.

### Preparation of Negative Electrode Plate in Example 1:

A negative electrode active material graphite (crystallinity Lc=32 nm), a binder styrene-butadiene rubber, and a dispersant carboxymethyl cellulose sodium were dissolved in deionized water at a weight ratio of 98:1:1 to form a first slurry. A copper foil was used as a negative electrode current collector, and the first slurry was applied to the negative electrode current collector, with a coating weight of 30 mg/1540 mm², to obtain a first layer A negative electrode active material graphite (crystallinity Lc=25 nm), a binder styrene-butadiene rubber, and a dispersant carboxymethyl cellulose sodium were dissolved in deionized water at a weight ratio of 98:1:1 to form a second slurry. The second slurry was applied to the first layer, with a coating weight of 120 mg/1540 mm², to obtain a second layer, followed by drying, cold pressing, and cutting, to obtain a negative electrode plate. The cold-pressed electrode plate included the second layer of about 23 μm and the first layer of about 92 μm.

Examples 2 to 6 were different in crystallinity Lc of graphite in the first layer and/or the second layer. Specific parameter differences are shown in Table 1 below.

The following describes methods for testing parameters of this application.

### (1) Comparison of Lithium Precipitation Interfaces:

At a test environment temperature of 25° C., lithium-ion batteries were subjected to 10 charge and discharge cycles in the same charging process, and disassembled, and negative electrode plates were observed to compare the lithium precipitation interfaces. Charging process:
step 1: the lithium-ion battery was charged to 4.5 V at a constant current of 2 C;
step 2: the lithium-ion battery was charged to 0.05 C at a constant voltage of 4.5 V;
step 3: the lithium-ion battery was left standing for 5 min;
step 4: the lithium-ion battery was discharged to 3.0 V at a constant current of 0.5 C;
step 5: the lithium-ion battery was left standing for 5 min; and
step 6: the above steps 1 to 5 were repeated for 10 cycles in total.

### (2) Capacity Retention Rate:

At a test environment temperature of 25° C., the lithium-ion batteries were subjected to 600 cycles in the same charging process. Then, a discharge capacity after 600 charge and discharge cycles was divided by a discharge capacity during the first cycle to obtain a capacity retention rate. Charging process:
step 1: the lithium-ion battery was charged to 4.5 V at a constant current of 2 C;
step 2: the lithium-ion battery was charged to 0.05 C at a constant voltage of 4.5 V;
step 3: the lithium-ion battery was left standing for 5 min;
step 4: the lithium-ion battery was discharged to 3.0 V at a constant current of 0.5 C;
step 5: the lithium-ion battery was left standing for 5 min; and
step 6: the above steps 1 to 5 were repeated for 600 cycles in total.

Table 1 shows various parameters and evaluation results in Examples 1 to 6 and Comparative examples 1 to 3.

TABLE 1

| | | | Ratio of | | |
|---|---|---|---|---|---|
| | | | crystallinity | | |
| | | | of | | |
| | Crystal- | | graphite | | |
| | linity | Crystal- | in second | | |
| | of | linity | layer to | | |
| | graphite | of | crystallinity | | |
| | in | graphite | of | | Capacity |
| | second | in first | graphite in | Lithium | retention |
| | layer | layer | first layer | precipitation | rate |
| Comparative | 20 nm, coating on one layer | | | No lithium | 90% |
| example 1 | | | | precipitation | |
| Comparative | 25 nm, coating on one layer | | | No lithium | 92% |
| example 2 | | | | precipitation | |
| Comparative | 28 nm, coating on one layer | | | No lithium | 90% |
| example 3 | | | | precipitation | |
| Comparative | 35 nm, coating on one layer | | | Lithium | 87% |
| example 4 | | | | precipitation | |
| Example 1 | 25 nm | 32 nm | 0.78 | No lithium | 95% |
| | | | | precipitation | |
| Example 2 | 25 nm | 35 nm | 0.71 | No lithium | 95% |
| | | | | precipitation | |
| Example 3 | 20 nm | 35 nm | 0.57 | No lithium | 92% |
| | | | | precipitation | |
| Example 4 | 20 nm | 50 nm | 0.4 | No lithium | 91% |
| | | | | precipitation | |
| Example 5 | 28 nm | 35 nm | 0.8 | No lithium | 92% |
| | | | | precipitation | |
| Example 6 | 25 nm | 36 nm | 0.69 | No lithium | 93% |
| | | | | precipitation | |

Through comparison of Comparative examples 1, 3, 4 and Example 3, it can be seen that with the use of a double-layer coating design, the crystallinity of graphite in the first layer is higher, and the crystallinity of graphite in the second layer is lower, alleviating the lithium precipitation and increasing the capacity retention rate of the lithium-ion batteries. Similarly, the same conclusion can be drawn by comparing Comparative example 2 and Example 1. This is mainly because the second layer away from the negative electrode current collector contains low-crystallinity graphite, which is conducive to lithium-ion intercalation and deintercalation, and makes lithium precipitation less likely to occur, and the first layer close to the negative electrode current collector contains high-crystallinity graphite, which can achieve a high capacity. Therefore, in a case of not losing the capacity, the kinetic performance and cycling performance of the lithium-ion battery can be improved.

Additionally, through comparison of Examples 1 to 6, it can be known that when a ratio of the crystallinity of graphite in the second layer to the crystallinity of graphite in the first layer is 0.4 to 0.8, as the ratio increases, the capacity retention rate tends to first increases and then decreases.

Table 2 shows parameters and evaluation results in Examples 7 to 12. Thicknesses of the first layer and second layer in Examples 7 to 12 were different from that in Example 3, but other aspects were the same as in Example 3.

TABLE 2

| | | | Ratio of | | | | | |
|---|---|---|---|---|---|---|---|---|
| | | | crystallinity | | | | | |
| | | | of graphite | | | | | |
| | | | in second | | | | | |
| | | | layer to | | | Thickness | | |
| | Crystallinity | | crystallinity | Thickness | Thickness | ratio of | | |
| | of graphite | Crystallinity | of graphite | of first | of second | first layer | | Capacity |
| | in second | of graphite | in first | layer | layer | to second | Lithium | retention |
| | layer | in first layer | layer | (μm) | (μm) | layer | precipitation | rate |
| Example | 20 nm | 35 nm | 0.57 | 100 | 15 | 6.7 | No lithium | 87% |
| 7 | | | | | | | precipitation | |
| Example | 20 nm | 35 nm | 0.57 | 95 | 20 | 4.8 | No lithium | 90% |
| 8 | | | | | | | precipitation | |
| Example | 20 nm | 35 nm | 0.57 | 91 | 24 | 3.8 | No lithium | 91% |
| 9 | | | | | | | precipitation | |
| Example | 20 nm | 35 nm | 0.57 | 87 | 28 | 3.1 | No lithium | 90% |
| 10 | | | | | | | precipitation | |
| Example | 20 nm | 35 nm | 0.57 | 77 | 38 | 2.0 | No lithium | 86% |
| 11 | | | | | | | precipitation | |
| Example | 20 nm | 35 nm | 0.57 | 58 | 57 | 1.0 | No lithium | 84% |
| 12 | | | | | | | precipitation | |

Through comparison of Examples 7 to 12, it can be known that as a thickness ratio of the first layer to the second layer decreases, the capacity retention rate first increases and then decreases. When the thickness ratio of the first layer to the second layer is in the range of 3 to 5, the capacity retention rate can be maintained above 90%.

The foregoing descriptions are merely preferred examples of this application and explanations of the technical principles used. Persons skilled in the art should understand that the related scope disclosed in this application is not limited to the technical solutions formed by a specific combination of the foregoing technical characteristics, and should also cover other technical solutions formed by any combination of the foregoing technical characteristics or their equivalent characteristics. For example, a technical solution formed by replacement between the foregoing characteristics and technical characteristics having similar functions disclosed in this application.

What is claimed is:

1. An electrochemical apparatus, comprising:
a negative electrode plate; wherein the negative electrode plate comprises a negative electrode current collector, a first layer, and a second layer; the first layer is located between the negative electrode current collector and the second layer;
wherein the first layer and the second layer both comprise graphite, and a ratio of a crystallinity of the graphite in the second layer to a crystallinity of the graphite in the first layer is 0.4 to 0.8.

2. The electrochemical apparatus according to claim 1, wherein the crystallinity of the graphite in the second layer is 20 nm to 28 nm.

3. The electrochemical apparatus according to claim 1, wherein the crystallinity of the graphite in the first layer is 30 nm to 50 nm.

4. The electrochemical apparatus according to claim 1, wherein a thickness ratio of the first layer to the second layer is 3 to 5.

5. The electrochemical apparatus according to claim 1, wherein a mass percentage of the graphite in the first layer is 70% to 98%.

6. The electrochemical apparatus according to claim 1, wherein a mass percentage of the graphite in the second layer is 70% to 98%.

7. The electrochemical apparatus according to claim 1, wherein the first layer further comprises a first binder and a first dispersant, and the second layer comprises a second binder and a second dispersant.

8. The electrochemical apparatus according to claim 7, wherein the first binder and the second binder each independently comprise at least one of polyacrylic acid, polyvinylpyrrolidone, polyanion, polyimide, polyamide-imide, polysiloxane, styrene-butadiene rubber, epoxy resin, polyester resin, polyurethane resin, or polyfluorene.

9. The electrochemical apparatus according to claim 7, wherein the first dispersant and the second dispersant each independently comprise at least one of carboxymethyl cellulose or carboxymethyl cellulose salt.

10. An electronic apparatus, comprising the electrochemical apparatus according to claim 1.

11. The electronic apparatus according to claim 10, wherein the crystallinity of the graphite in the second layer is 20 nm to 28 nm.

12. The electronic apparatus according to claim 10, wherein the crystallinity of the graphite in the first layer is 30 nm to 50 nm.

13. The electronic apparatus according to claim 10, wherein a thickness ratio of the first layer to the second layer is 3 to 5.

14. The electronic apparatus according to claim 10, wherein a mass percentage of the graphite in the first layer is 70% to 98%.

15. The electronic apparatus according to claim 10, wherein a mass percentage of the graphite in the second layer is 70% to 98%.

16. The electronic apparatus according to claim 10, wherein \the first layer further comprises a first binder and a first dispersant, and the second layer comprises a second binder and a second dispersant.

17. The electronic apparatus according to claim 16, wherein the first binder and the second binder each independently comprise at least one of polyacrylic acid, polyvinylpyrrolidone, polyanion, polyimide, polyamide-imide, polysiloxane, styrene-butadiene rubber, epoxy resin, polyester resin, polyurethane resin, or polyfluorene.

18. The electronic apparatus according to claim 16, wherein the first dispersant and the second dispersant each independently comprise at least one of carboxymethyl cellulose or carboxymethyl cellulose salt.

19. The electrochemical apparatus according to claim 2, wherein the crystallinity of the graphite in the first layer is 30 nm to 50 nm.
